(19) United States
(12) Patent Application Publication
(10) Pub. No.: US 2013/0168509 A1
(43) Pub. Date: Jul. 4, 2013

(54) CABLE ARRANGEMENT DEVICE FOR CABLE MANAGEMENT ARM

(71) Applicants: KEN-CHING CHEN, Kaohsiung City (TW); SHUN-HO YANG, Kaohsiung City (TW); CHENG-HUI YANG, Kaohsiung City (TW); CHUN-CHIANG WANG, Kaohsiung City (TW)

(72) Inventors: KEN-CHING CHEN, Kaohsiung City (TW); SHUN-HO YANG, Kaohsiung City (TW); CHENG-HUI YANG, Kaohsiung City (TW); CHUN-CHIANG WANG, Kaohsiung City (TW)

(73) Assignees: KING SLIDE TECHNOLOGY CO., LTD., KAOHSIUNG CITY (TW); KING SLIDE WORKS CO., LTD., KAOHSIUNG CITY (TW)

(21) Appl. No.: 13/342,401

(22) Filed: Jan. 3, 2012

(51) Int. Cl. F16L 3/10

(52) U.S. Cl. 248/74.1

(57) ABSTRACT

A cable arrangement device for a cable management arm includes a support member and a locking member. The support member includes a fixing portion, an accommodation portion and a hook portion. The accommodation portion includes a first sidewall, a second sidewall and a bottom wall connected between the first and second sidewalls. The first sidewall is fixed to the fixing portion and has a connection member which has a first pivotal portion which has a positioning feature. The second sidewall is fixed to the hook portion. The locking member has a second pivotal portion and an engaging portion. The second pivotal portion is pivotably connected to the first pivotal portion and has an engaging feature engaged with the positioning feature. The engaging portion is engaged with the hook portion of the first sidewall when the engaging portion is in locked position.

### FIELD OF THE INVENTION

The present invention relates to a cable arrangement device for a cable management arm, and more particularly, to a cable arrangement device for quickly positioning or detaching the cables relative to the cable management arm.

### BACKGROUND OF THE INVENTION

U.S. Pat. No. 7,473,846 to Doerr discloses a “Reversible cable support arm” and a cable support arm 24 is connected to the rails 108 as shown in FIGS. 2 to 11, wherein the cable support arm 24 has multiple cable support features 48 which are a U-shaped metal wire and one side of the U-shaped wire is fixed to the cable support arm 24 and the other side of the U-shaped wire is located to form an L shape arrangement with the horizontal section of the U-shaped metal wire so as to accommodate and support the cables.

However, the cable support features 48 of the cable support arm 24 are a hook-like member facing upward, the cables can be quickly positioned, the cables may drop from the open top.

When using the cable support arm 24, the two ends of the cable support arm are pulled to be straight or bent to be overlapped to each other. Obviously, the cables on the cable support arm will be pulled or bent. That is to say, the cables are easily shifted or deformed relative to the cable support features and drop from the open top of the cable support features.

The present invention intends to provide a cable arrangement device to improve the shortcomings mentioned above.

### SUMMARY OF THE INVENTION

The present invention relates to a cable arrangement device for a cable management arm and comprises a support member and a locking member, wherein the support member includes a fixing portion, an accommodation portion and a hook portion. The accommodation portion includes a first sidewall, a second sidewall and a bottom wall connected between the first and second sidewalls. The first sidewall is fixed to the fixing portion and has a connection member which has a first pivotal portion which has a positioning feature. The second sidewall is fixed to the hook portion. The locking member has a second pivotal portion and an engaging portion. The second pivotal portion is pivotably connected to the first pivotal portion of the support member. The second pivotal portion has an engaging feature engaged with the positioning feature of the connection member. The engaging portion is engaged with the hook portion of the first sidewall when the engaging portion is in locked position.

The primary object of the present invention is to provide a cable arrangement device for a cable management arm so as to improve the shortcoming of the conventional cable arrangement device wherein the cables are easily dropped from the cable support features.

Preferably, the first pivotal portion of the connection member of the accommodation portion is located above the first sidewall so that when the locking member is opened, the first pivotal portion is located upright above the first sidewall.

Preferably, the first pivotal portion of the connection member of the support member and the second pivotal portion of the locking member are a hole and a protrusion respectively.

Preferably, the positioning feature of the connection member of the support member is a recess and the engaging feature of the second pivotal portion of the locking member is a protrusion.

Preferably, the connection member has a first recess with which the engaging feature is engaged when the engaging portion of the locking member is locked with the hook portion of the support member.

Preferably, the connection member has a second recess. When the locking member is locked with the support member, the second pivotal portion of the locking member is engaged with the first pivotal portion of the connection member of the support member via the second recess.

Preferably, the hook portion is a hook.

Preferably, the engaging portion of the locking member is a hook which is located corresponding to the hook portion.

Preferably, the engaging portion of the locking member includes an inclined surface which is located corresponding to the hook portion.

Preferably, the hook portion of the support member includes an inclined surface which is located corresponding to the engaging portion.

When the locking member is engaged with the support member, the engaging portion the locking member is engaged with the hook portion of the support member, and in the meanwhile, the engaging feature of the locking member is engaged with the first recess of the support member. When the user opens the cable arrangement device to take the cables, the cable arrangement device is slightly engaged with the second sidewall to let the second sidewall of the support member be deformed toward the first sidewall. The hook portion on the second sidewall is then disengaged from the engaging portion, and the locking member is rotated. The engaging feature is disengaged from the first recess and is engaged with the positioning feature. The locking member is positioned upright so that the cables can be easily installed in the cable arrangement device, or removed from the cable arrangement device. Because the locking member is positioned upright, the cables are not impeded by the locking member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show that the cable arrangement device of the present invention is cooperated with a cable management arm;

FIG. 2 is an exploded view to show the cable arrangement device of the present invention;

FIG. 3 is a perspective view to show the cable arrangement device of the present invention;

FIG. 4 shows that locking member of the cable arrangement device of the present invention is engaged with the support member, and

FIG. 5 shows that locking member of the cable arrangement device of the present invention is released and the firs sidewall that is located upright is opened.

### DETAILED DESCRIPTION OF THE PREFERRED EMBODIMENT

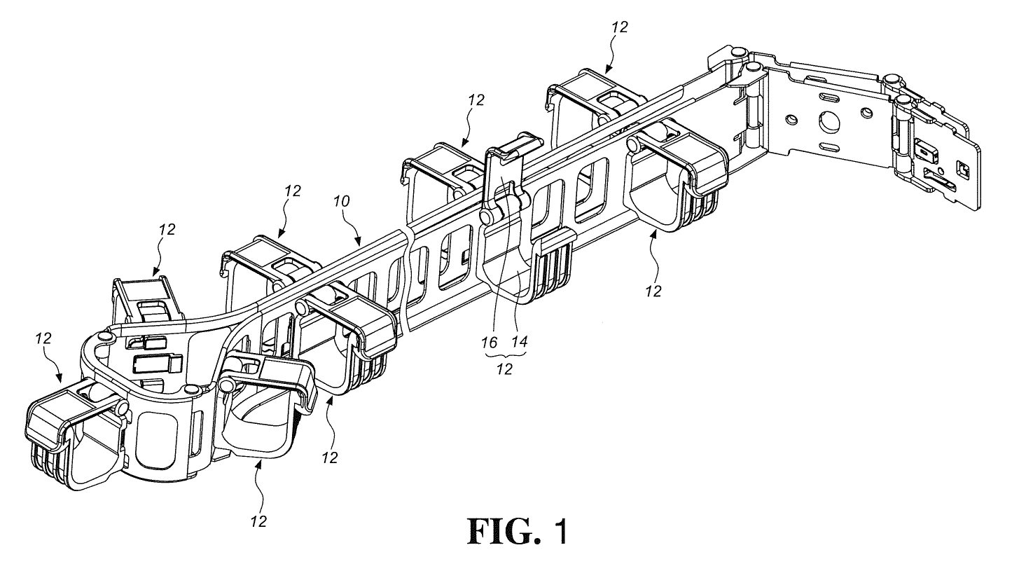

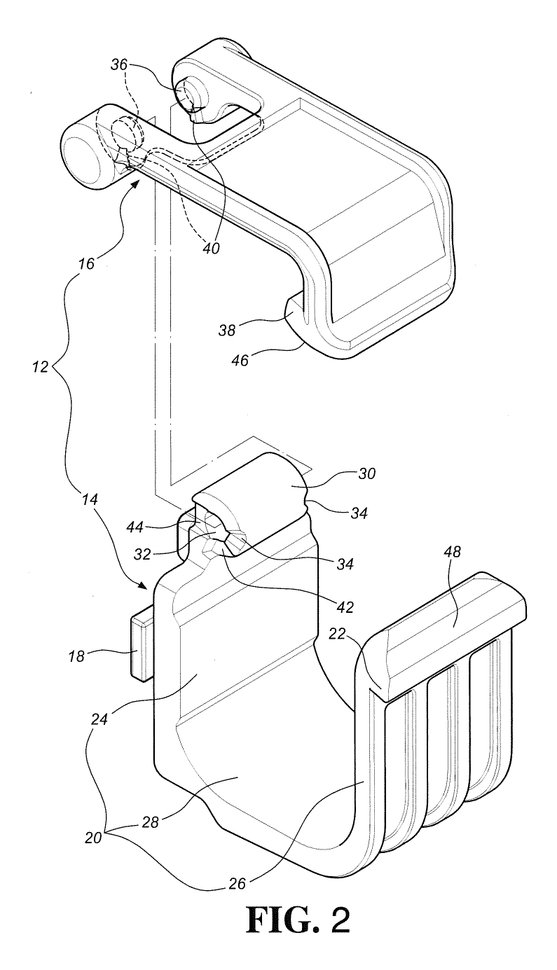

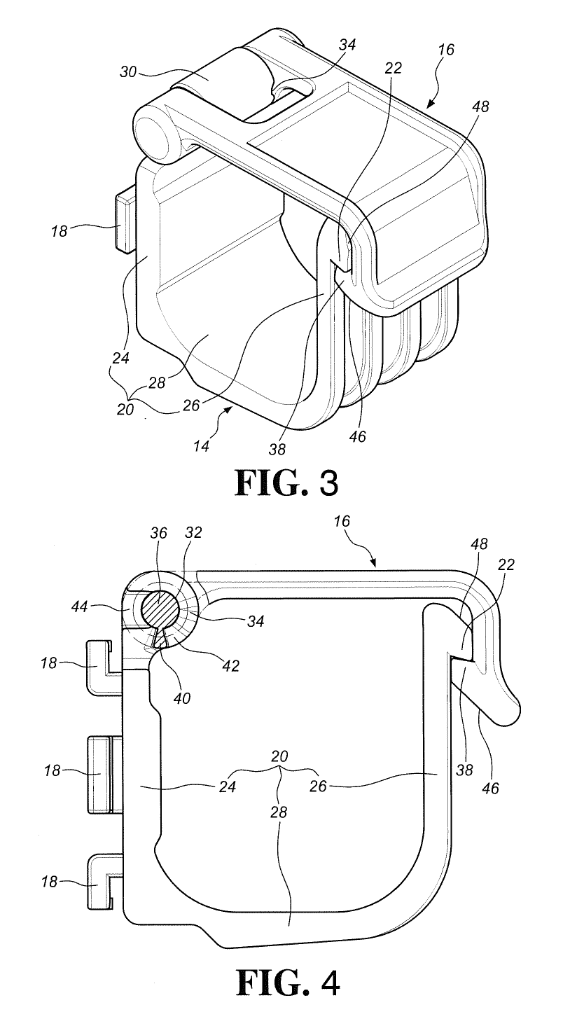

Referring to FIGS. 1 to 3, the cable arrangement device 12 of the present invention comprises a support member 14 and a locking member 16 pivotably connected to the support member 14. As shown in FIGS. 2 and 3, the support member 14 has a fixing portion 18, an accommodation portion 20 and a hook portion 22. The accommodation portion 20 has a first sidewall 24, a second sidewall 26 and a bottom wall 28 connected between the first and second sidewalls 24, 26. The first sidewall 24, the second sidewall 26 and the bottom wall 28 define a U-shaped body. The first sidewall 24 is fixed to the fixing portion 18, for example, the fixing portion 18 extends from the first sidewall 24. In a preferable embodiment, the first sidewall 24 has a connection member 30 which has a first pivotal portion 32. For example, the first pivotal portion 32 is a hole. The first pivotal portion 32 has a positioning feature 34 defined in a periphery thereof For example, the positioning feature 34 is a recess. The second sidewall 26 is fixed to the hook portion 22 which extends from the second sidewall 26. Because the accommodation portion 20 is a U-shaped body so that the second sidewall 26 is flexible relative to the first sidewall 24, and the hook portion 22 on the second sidewall 26 is able to change its position relative to the first sidewall 24 in resilient form.

The locking member 16 has a second pivotal portion 36 and an engaging portion 38, wherein the second pivotal portion 36 is a protrusion and pivotably connected to the first pivotal portion 32 of the support member 14. The second pivotal portion 36 has an engaging feature 40 defined in a periphery thereof, for example, the engaging feature 40 is a protrusion and engaged with the positioning feature 34 of the connection member 30. The engaging portion 38 is engaged with the hook portion 22 of the support member 14 when the engaging portion 38 is in locked position.

The first pivotal portion 32 of the connection member 30 of the accommodation portion 20 is located above the first sidewall 24 so that when the locking member 16 is opened, the first pivotal portion 32 is located upright above the first sidewall 24.

The connection member 30 has a first recess 42 and a second recess 44. When the engaging portion 38 of the locking member 16 is locked with the hook portion 22 of the support member 14, the engaging feature 40 is engaged with the first recess 42 so that the locking member 16 is not disengaged from the support member 14 due to be expanded. Alternatively, when the locking member 16 is locked with the support member 14, the second pivotal portion 36 of the locking member 16 is connected with the first pivotal portion 32 of the connection member 30 of the support member 14 via the second recess 44.

The hook portion 22 is a hook and the engaging portion 38 of the locking member 16 is a hook which is located corresponding to the hook portion 22.

The engaging portion 38 of the locking member 16 includes an inclined surface 46 which is located corresponding to the hook portion 22. The hook portion 22 of the support member 14 includes an inclined surface 48 which is located corresponding to the engaging portion 38.

As shown in FIG. 4, when in operation, the locking member 16 is engaged with the support member 14, and the engaging portion 38 of the locking member 16 is located corresponding to the hook portion 22 of the support member 14 and hook to the hook portion 22. The engaging feature 40 of the locking member 16 engages with the first recess 42 so that the pivotal connection between the locking member 16 and the support member 14 is not released due to being expanded.

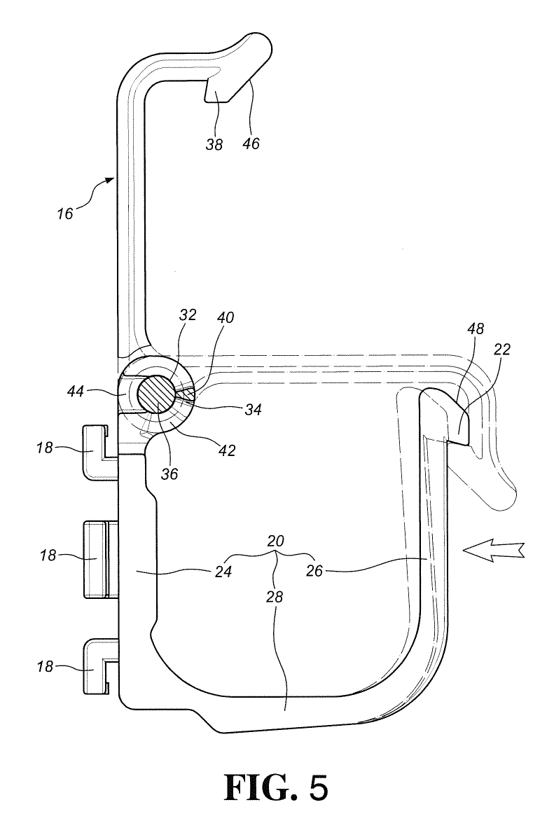

As shown in FIG. 5, when in operation, the locking member 16 is released and opens the upright first sidewall 24 of the support member 14. When the user slightly presses the cable arrangement device 12 onto the second sidewall 26, the second sidewall 26 is deformed resiliently toward the first sidewall 24 and the hook portion 22 of the second sidewall 26 is disengaged from the engaging portion 38 of the locking member 16. The locking member 16 is rotated so that the engaging feature 40 of the locking member 16 is removed from the first recess 42 and engaged with the positioning feature 34 to temporarily position the locking member 16 upright. Therefore, the user can easily position the cables (not shown) in the cable arrangement device 12 or remove the cables (not shown) from the cable arrangement device 12. Because the locking member 16 is temporarily positioned, the locking member 16 does not impede the positioning of the cables. Especially, as shown in FIG. 1, when there are multiple cable arrangement devices 12 connected to the cable management arm 10, each cable arrangement device 12 temporarily positions the locking member 16 upright, so that the cables (not shown) are conveniently positioned in the cable arrangement devices 12 one by one.

While we have shown and described the embodiment in accordance with the present invention, it should be clear to those skilled in the art that further embodiments may be made without departing from the scope of the present invention.

1. A cable arrangement device for a cable management arm, comprising:
a support member having a fixing portion, an accommodation portion and a hook portion, the accommodation portion having a first sidewall, a second sidewall and a bottom wall connected between the first and second sidewalls, the first sidewall fixed to the fixing portion and having a connection member, the connection member having a first pivotal portion which has a positioning feature defined in a periphery thereof, the second sidewall fixed to the hook portion; and
a locking member having a second pivotal portion and an engaging portion, the second pivotal portion pivotably connected to the first pivotal portion of the support member, the second pivotal portion having an engaging feature defined on a periphery thereof, the engaging feature is configured to engage with the positioning feature of the connection member, whereby when the engaging feature is engaged with the positioning feature, the engaging portion is positioned in a released position; the engaging portion is engaged with the hook portion of the second sidewall when the engaging portion is in a locked position.

2. The device as claimed in claim 1, wherein the first pivotal portion of the connection member of the accommodation portion is located above the first sidewall so that when the locking member is opened, the first pivotal portion is located upright above the first sidewall.

3. The device as claimed in claim 1, wherein the first pivotal portion of the connection member of the support member and the second pivotal portion of the locking member are a hole and a protrusion respectively.

4. The device as claimed in claim 1, wherein the positioning feature of the connection member of the support member is a recess and the engaging feature of the second pivotal portion of the locking member is a protrusion.

5. The device as claimed in claim 1, wherein the connection member has a first recess with which the engaging feature is engaged when the engaging portion of the locking member is locked with the hook portion of the support member.

6. The device as claimed in claim 1, wherein the connection member has a second recess, when the locking member is locked with the support member, the second pivotal portion of the locking member is engaged with the first pivotal portion of the connection member of the support member via the second recess.

7. The device as claimed in claim 1, wherein the hook portion is a hook.

8. The device as claimed in claim 7, wherein the engaging portion of the locking member is a hook which is located corresponding to the hook portion.

9. The device as claimed in claim 8, wherein the engaging portion of the locking member includes an inclined surface which is located corresponding to the hook portion.

10. The device as claimed in claim 9, wherein the hook portion of the support member includes an inclined surface which is located corresponding to the engaging portion.
